(19) United States
(12) Patent Application Publication
(10) Pub. No.: US 2026/0163906 A1
(43) Pub. Date: Jun. 11, 2026

(54) SYSTEM AND METHOD FOR LEAKED CREDENTIAL VALIDATION

(71) Applicant: Cycognito, Ltd., Tel Aviv (IL)

(72) Inventor: Rob N. GURZEEV, Palo Alto, CA (US)

(73) Assignee: Cycognito, Ltd., Tel Aviv (IL)

(21) Appl. No.: 18/974,096

(22) Filed: Dec. 9, 2024

(51) Int. Cl. G06F 21/45; H04L 9/40

(52) U.S. Cl. CPC G06F 21/45; H04L 63/0407

(57) ABSTRACT

A system and method for validating compromised credentials of an organization is presented. The method includes detecting a plurality of compromised credentials, each compromised credential including a user identifier and a password; detecting a plurality of web resources associated with an organization, each web resource including a login; generating an instruction to access a web resource of the plurality of web resources based on a detected compromised credential; and initiating a remediation action in response to determining that the instruction, when executed, results in access of the web resource.

### TECHNICAL FIELD

The present disclosure relates generally to cybersecurity, and specifically to validating leaked credentials.

### BACKGROUND

Leaked credentials refer to usernames, passwords, or other authentication details that have been exposed, often through data breaches, phishing attacks, or poor security practices. These credentials can end up on the dark web or public forums, where they are accessed and exploited by cybercriminals.

The primary issue with leaked credentials is that they allow unauthorized access to systems, applications, or accounts, often without raising immediate suspicion. This poses a significant risk to personal, organizational, and customer data, as attackers can escalate their access to sensitive information or systems.

Leaked credentials also undermine trust, particularly when the breach involves customer accounts. They can lead to financial losses, reputational damage, and regulatory penalties for organizations. Furthermore, leaked administrative or privileged credentials exacerbate the problem, as attackers can use them to access critical infrastructure or escalate their privileges, causing widespread harm. The sheer scale and frequency of credential leaks make them a persistent threat in the cybersecurity landscape.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include detecting a plurality of compromised credentials, each compromised credential including an user identifier and a password. The method may also include detecting a plurality of web resources associated with an organization, each web resource including a login. The method may furthermore include generating an instruction to access a web resource of the plurality of web resources based on a detected compromised credential. The method may in addition include initiating a remediation action in response to determining that the instruction, when executed, results in access of the web resource. Other embodiments of this aspect include corresponding computer systems, apparatus, and computer programs recorded on one or more computer storage devices, each configured to perform the actions of the methods.

Implementations may include one or more of the following features. The method may include: initiating resource discovery to detect each of the plurality of web resources. The method may include: detecting in an user identifier of a compromised credential an identifier of the organization; and generating the instruction only in response to detecting the identifier of the organization. The method may include: detecting a compromised credential associated with a first user identifier; detecting a second user identifier associated with the organization, where the second user identifier is semantically similar to the first user identifier; and generating the instruction to access the web resource based on the second user identifier and a password of the detected compromised credential. The method may include: detecting a digital asset associated with an external attack surface including a web resource of the plurality of web resources; and generating an access instruction for the digital asset in response to determining that the digital asset is associated with the external attack surface of the organization. The method may include: generating a plurality of permutations based on the compromised credentials; and generating a plurality of instructions to access the web resource, each instruction based on a permutation of the compromised credentials. The method may include: configuring a generative artificial intelligence (AI) model to generate the plurality of permutations based at least on an user identifier of a compromised credential. The method may include: configuring a generative AI model to generate the plurality of permutations based at least on a password of a compromised credential. Implementations of the described techniques may include hardware, a method or process, or a computer tangible medium.

In one general aspect, non-transitory computer-readable medium may include one or more instructions that, when executed by one or more processors of a device, cause the device to: detect a plurality of compromised credentials, each compromised credential including an user identifier and a password; detect a plurality of web resources associated with an organization, each web resource including a login; generate an instruction to access a web resource of the plurality of web resources based on a detected compromised credential; and initiate a remediation action in response to determining that the instruction, when executed, results in access of the web resource. Other embodiments of this aspect include corresponding computer systems, apparatus, and computer programs recorded on one or more computer storage devices, each configured to perform the actions of the methods.

In one general aspect, system may include one or more processors configured to: detect a plurality of compromised credentials, each compromised credential including an user identifier and a password. The system may furthermore detect a plurality of web resources associated with an organization, each web resource including a login. The system may in addition generate an instruction to access a web resource of the plurality of web resources based on a detected compromised credential. The system may moreover initiate a remediation action in response to determining that the instruction, when executed, results in access of the web resource. Other embodiments of this aspect include corresponding computer systems, apparatus, and computer programs recorded on one or more computer storage devices, each configured to perform the actions of the methods.

Implementations may include one or more of the following features. The system where the one or more processors are further configured to: initiate resource discovery to detect each of the plurality of web resources. The system where the one or more processors are further configured to: detect in an user identifier of a compromised credential an identifier of the organization; and generate the instruction only in response to detecting the identifier of the organization. The system where the one or more processors are further configured to: detect a compromised credential associated with a first user identifier; detect a second user identifier associated with the organization, where the second user identifier is semantically similar to the first user identifier; and generate the instruction to access the web resource based on the second user identifier and a password of the detected compromised credential. The system where the one or more processors are further configured to: detect a digital asset associated with an external attack surface including a web resource of the plurality of web resources; and generate an access instruction for the digital asset in response to determining that the digital asset is associated with the external attack surface of the organization. The system where the one or more processors are further configured to: generate a plurality of permutations based on the compromised credentials; and generate a plurality of instructions to access the web resource, each instruction based on a permutation of the compromised credentials. The system where the one or more processors are further configured to: configure a generative artificial intelligence (AI) model to generate the plurality of permutations based at least on an user identifier of a compromised credential. The system where the one or more processors are further configured to: configure a generative AI model to generate the plurality of permutations based at least on a password of a compromised credential. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a computing environment having persistent digital assets discovered by an external attack surface detector, utilized to describe an embodiment.

FIG. 2 is an example diagram of a credential detector operating on a private computing environment, implemented in accordance with an embodiment.

FIG. 3 is an example flowchart of a method for validating compromised credentials for an organization utilizing a computing environment, implemented in accordance with an embodiment.

FIG. 4 is an example schematic diagram of a credential detector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to an embodiment, a system is configured to detect persistent digital assets through an external attack surface. In an embodiment, detecting a persistent digital asset is beneficial, as having an accurate view of an external attack surface is beneficial, for example for cybersecurity mitigation, remediation, and the like.

In some embodiments, a representation of a digital asset is generated based on information detected through a public network, such as the Internet. In an embodiment, information pertaining to a digital asset changes over time. For example, a digital asset has a first state at a first point of time, and a second state at a second point in time. In an embodiment, a state includes an IP address, an operating system, a viable network communication port, combinations thereof, and the like, as explained in more detail with respect to embodiments herein.

In an embodiment, it is beneficial to detect persistent digital assets, despite changes such as software updates, IP address changes, domain name changes, and the like, which occur over time.

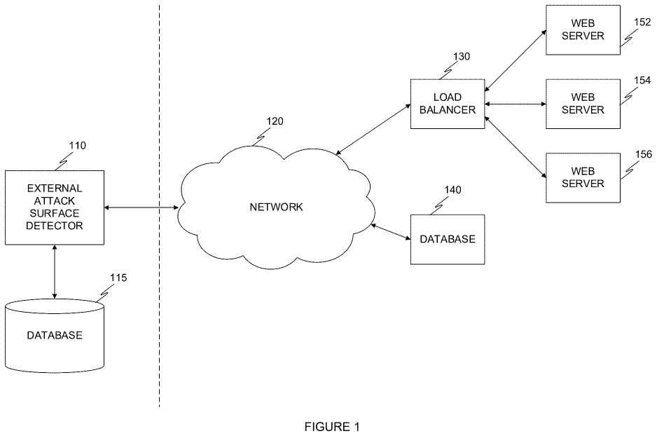

FIG. 1 is a network diagram of a computing environment having persistent digital assets discovered by an external attack surface detector, utilized to describe an embodiment. A network computing environment, according to an embodiment, includes virtual digital assets, physical digital assets, combinations thereof, and the like. In an embodiment, a virtual digital asset is a virtual machine, a software container, a serverless function, a virtual appliance, an application image, a web server, a load balancer, a database, a distributed storage service, a combination thereof, and the like.

In some embodiments, a physical digital asset is a bare metal machine, a server rack, a processor, a memory, a storage, combinations thereof, and the like.

In an embodiment, a computing environment includes a load balancer 130, which exposes web servers, such as a first web server 152, a second web server 154, and a third web server 156. In some embodiments, the computing environment includes a database 140. In certain embodiments, the computing environment, elements thereof, and the like, are connected to a network 120.

In some embodiments, the network 120 includes, but is not limited to, a wireless, cellular or wired network, a local area network (LAN), a wide area network (WAN), a metro area network (MAN), the Internet, the worldwide web (WWW), similar networks, and any combination thereof.

According to an embodiment, a computing environment includes an external attack surface. An external attack surface includes, in an embodiment, machines, devices, digital assets, physical assets, and the like, which are exposed through a network 120, an external network (i.e., a network which is external to a network of the computing environment), a public network, combinations thereof, and the like.

For example, in an embodiment, a load balancer 130 is part of a computing environment's external attack surface, as the load balancer 130 is exposed to a network which includes network elements that are not part of the computing environment. For example, a load balancer 130 that is exposed to the Internet is part of an attack surface, according to an embodiment. Gaining access through an external attack surface is a common way attackers gain access to network computing environments. It is therefore advantageous to detect an organization's external attack surface, so that cybersecurity measures can be put in place, including deterring attackers, remediate attacks, mitigate attacks, and the like.

In certain embodiments, an external attack surface detector 110 is configured to detect a computing environment's external attack surface. In some embodiments, a computing environment is a cloud computing environment, a networked computing environment, a hybrid computing environment, a combination thereof, and the like.

In some embodiments, a cloud computing environment is a virtual private cloud (VPC), a virtual network (VNet), and the like. In certain embodiments, a cloud computing environment is deployed on a cloud computing infrastructure, such as Amazon® Web Services (AWS), Google® Cloud Platform (GCP), Microsoft® Azure®, and the like.

In an embodiment, an external attack surface detector 110 is configured to detect the computing environment's external attack surface, based on an identifier of an organization. For example, according to an embodiment, a detector 110 is configured to detect a domain name service (DNS) record based on the organization identifier. In an embodiment, a DNS record is detected by querying a DNS server with the organization identifier. An organization identifier is, for example, a legal entity name, a subsidiary name, a tax ID number, a company ID number, a combination thereof, and the like.

In certain embodiments, a DNS query returns a response including a plurality of network addresses. For example, according to an embodiment, a DNS query response includes a static IP address, a dynamic IP address, a combination thereof, and the like.

In an embodiment, a network protocol message is generated based on a network address detected in the DNS query response. For example, in an embodiment, a network protocol message includes generating a PING command to an IP address, a range of IP addresses, and the like, and receive a response to the network protocol message.

In certain embodiments, the network protocol is TCP/IP, UDP, HTTP, SSH, a combination thereof, and the like. In some embodiments, the network protocol message is delivered over a unique port, a plurality of unique ports, and the like. For example, in an embodiment, an HTTP message is generated, and the same message is transmitted over port 80 and port 8080 to the same IP address.

According to an embodiment, a reply is received in response to sending the network protocol message. For example, in an embodiment, an HTTP response includes a code, such as 404, 503, etc. In certain embodiments, a detector 110 is configured to generate a representation of a digital asset based on a predefined data schema, and store such a representation in a database 115. For example, in an embodiment, the detector 110 is configured to generate a representation of a digital asset based on digital asset information.

In an embodiment, digital asset information includes a network address, a network address range, a domain identifier, a sub-domain name, a namespace identifier, a MAC address, an operating system identifier, an application version, an application identifier, a certificate, a hash of a certificate, a checksum result, a web application, an HTML code, a combination thereof, and the like.

In an embodiment, the detector 110 is configured to extract a value from digital asset information, and store the extracted value in a representation of the digital asset, for example in the database 115. Digital assets are often not static across time, which presents a challenge in identifying persistent digital assets. As a simple example, a digital asset has a first IP address at a first time, and a second IP address at a second time. This can occur, for example, due to a change in a static IP of a domain. In an embodiment, such a change is detected based on a DNS record.

In certain embodiments, the detector 110 is configured to detect when digital asset information applies to an existing digital asset (e.g., a change of IP address), or when digital asset information applies to a new digital asset. In some embodiments the detector 110 is configured to apply a policy, a rule, a conditional rule, a heuristic, a combination thereof, and the like, to determine if digital asset information is applied to a new digital asset or a previously detected digital asset.

In some embodiments, a digital asset representation includes a plurality of attributes, each attribute having a corresponding value. For example, in an embodiment, the detector 110 is configured to detect, extract, and the like, a value from digital asset information, and store such an extracted value in the digital asset representation of the digital asset.

In some embodiments, the detector is configured to determine if a digital asset information applies to a new digital asset or a previously detected digital asset based on a threshold. For example, in an embodiment, an attribute includes a threshold, a change threshold, and the like. In certain embodiments, where an attribute value changes at a frequency which exceeds the threshold, the digital asset information is determined to be of a new digital asset.

In certain embodiments, the threshold is applied to a number of attributes changing together. For example, where digital asset information includes the same IP address with a different port, for the same protocol, the detector 110 is configured to determine that the digital asset is the previously detected digital asset (i.e., only one attribute changed). In an embodiment, where the digital asset information includes a different IP address, a different port, and the same protocol, the detector 110 is configured to determine that the digital asset information applies to a new digital asset.

In some embodiments, certain changes are disregarded in determining if the digital asset is a previously detected digital asset or not. For example, where a DNS record indicates that a domain changed an IP address, then each digital asset associated with the domain has likely changed IP address as well, and therefore the digital asset information pertaining to that digital asset is determined based on other factors, attributes, and the like, which are not the IP address.

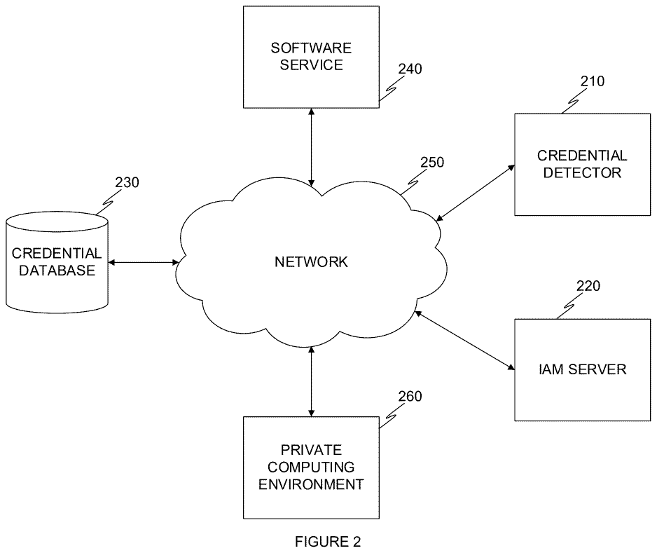

FIG. 2 is an example diagram of a credential detector operating on a private computing environment, implemented in accordance with an embodiment. In an embodiment, a private computing environment 260 is associated with an organization, for example an organization whose assets are detected utilizing an external attack surface detector 110 of FIG. 1 above. In an embodiment, an organization is associated with a plurality of assets, computing environments, etc.

In certain embodiments, organizations include a plurality of computing environments, each having their own credential system. For example, in an embodiment, an organization utilizes Microsoft® Azure with a Microsoft® account, and utilize G-Suite® with a Google® account. Each such account is associated with its own credential, e.g., username and password combination.

For example, in an embodiment, a user of the organization has a first credential utilized in the software service 240, and a second credential utilized in the private computing environment 260.

In an embodiment, a credential database 230 includes compromised credentials. For example, a compromised credential is a leaked password, leaked hash, leaked account information, leaked metadata, and the like. Leaked data is data which was considered private and subsequently became public or otherwise available to unauthorized parties, often through a cyber-attack, theft, etc.

In some embodiments, a credential detector 210 is configured to access the credential database 230 and detect a principal. For example, according to an embodiment, the credential detector 210 is configured to access an identity and access management server 220, an organization chart, an HR system, and the like, to detect principals associated with an organization. In an embodiment, the principals include identifiers, user accounts, service accounts, a first name, a last name, a title, and the like.

According to an embodiment, the credential detector is configured to determine if a principal, for example of the IAM server 220, is included in a credential database 230 including compromised credentials, leaked credentials, etc. In certain embodiments, for example, a match is detected between a handle of a user account detected in the IAM server 220 and a handle of a user account detected in the credential database 230.

In some embodiments, an organization's external attack surface includes digital assets deployed in a private computing environment 260, a software service 240, and the like. For example, in an embodiment, a private computing environment 260 is a cloud computing environment, including a virtual private cloud (VPC), a virtual network (VNet), a virtual private network (VPN), a combination thereof, and the like. In an embodiment, the private computing environment 260 is accessed using a first user account having a handle of ‘alicecharlie’, e.g., alicecharlie@example.com. The software service 240 is accessed by the user Alice using a second user account, such as acharlie@saas.com.

In an embodiment, the credential database 230 includes a compromised credential of acharlie@saas.com, which the credential detector 210 is configured to match to alicecharlie@example.com. In some embodiments, where a user such as Alice utilizes the same password, similar password, etc., in both systems, this can lead to a compromise of both systems.

According to an embodiment, the credential detector 210 is configured to detect principals associated with an organization and detect matches between such principals and compromised credentials. In an embodiment, the credential detector 210 includes a matching software module which is configured to determine a probability that a handle, user account, identifier, principal, and the like, matches a principal of the organization. In some embodiments, the matching software module includes a generative artificial intelligence (AI), which is configured to receive a prompt and generate an output which indicates, for example a probability, that a compromised credential of the credential database 230 matches with a principal of the organization.

In certain embodiments, the generative AI is a language model, such as a large language model, small language model, and the like. In some embodiments, the language model is a transformer model. In an embodiment, the matching software module is further configured to determine a Levenshtein distance between a credential from the credential database 230 and principal of the IAM server 220, where a credential matches a principal in response to determining that the Leventshtein distance is below a threshold.

In an embodiment, the credential detector 210 is configured to generate an access instruction. In some embodiments, the access instruction is based on a compromised credential, a detected credential (e.g., detected in the IAM server 220), a combination thereof, and the like. In some embodiments, a generative AI is configured to generate the access instruction, for example by generating permutations of a compromised password, permutations of a compromised user account, a combination thereof, and the like.

For example, in an embodiment, a generative AI is configured to output a plurality of handles, such as acharlie, alicec, a1ic3, etc., and generate an access instruction for each such handle based on a detected exposed password.

In an embodiment, the credential detector 210 is configured to detect a first compromised credential matching a credential utilized in the private computing environment 260. In some embodiments, the credential detector 210 is configured to detect a principal of the software service 240, for example in the IAM server 220, which utilizes a second credential to access the software service 240. In an embodiment, the credential detector 210 is configured to generate an access instruction using the detected principal and the first compromised credential, to determine if the software service 240 can be accessed using the compromised credential with the respective account information.

For example, Alice has an account with Microsoft which becomes compromised, leading to the account alicecharlie@microsoft.com and the associated password to be a compromised account. In an embodiment, the credential detector is configured to determine based on metadata of the account (e.g., Alice's name, title, etc.), the user handle, various combinations thereof, and the like, if a matching account is deployed in the identity and access management server 220. As an example, the credential detector 210 detects an account acharlie@gmail.com in the IAM server 220 which is utilized in accessing the software service 240.

In an embodiment, the credential detector 210 is configured to generate an access instruction for the software service 240 based on the password of the compromised account (e.g., alicecharlie@microsoft.com) and the account identifier of acharlie@gmail.com, to determine if the software service 240 can be accessed utilizing this credential. In some embodiments, the credential detector 210 is configured to generate a plurality of access instructions, for example based on permutations of the password (e.g., ‘Password1’, ‘Password2’, ‘P@ssw0rd!’, etc.).

According to an embodiment, this is advantageous as it allows an organization to detect potential compromised assets. Further, by detecting an external attack surface, and generating access instructions for assets based on the detected external attack surface, real gaps can be detected between multiple different platforms, environments, and the like which are used by an organization. Often these are non-trivial, for example an organization can acquire or merge with another organization, and systems, platforms, services, and the like, of one organization can put the other organization at risk, for example by having a compromised user in one organization, which uses the same credentials (e.g., same password) across all their different user accounts in the organization.

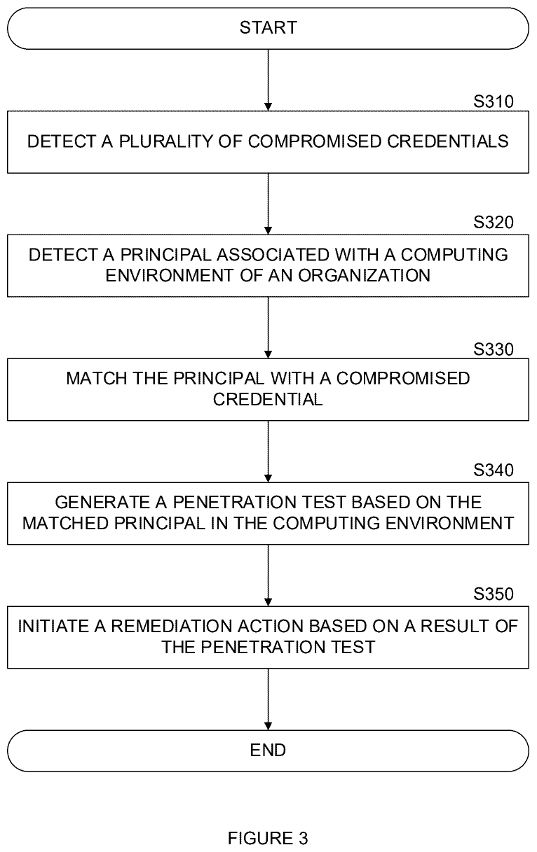

FIG. 3 is an example flowchart of a method for validating compromised credentials for an organization utilizing a computing environment, implemented in accordance with an embodiment.

At S310, a plurality of compromised credentials are detected. In an embodiment, a compromised credential includes a user name, an account name, an identifier, a password, a hash of a password, a combination thereof, and the like.

In certain embodiments, the compromised credentials are detected for example in a database, such as a column-oriented database. A compromised credential may be leaked for example by hackers, attackers, state actors, and the like. Typically, these can be found on the dark web.

In certain embodiments, compromised credentials are detected periodically, received periodically, received ad hoc, and the like. In an embodiment, the compromised credentials are accessed, for example by accessing a database containing therein credentials which are known to be compromised, suspected as being compromised, etc.

At S320, a principal is detected. In an embodiment, the principal is detected within a computing environment of an organization. For example, Acme Inc. is an organization associated with assets associated with the domain acme. com, and the domain oceanicair. com which belonged to the organization Oceanic Airlines which was acquired by Acme Inc.

In an embodiment, a principal, e.g., a user account, is detected in the organization of Acme Inc. by accessing an identity and access management service of the organization. In some embodiment, the principal is detected based on a human resource management software, a third party software as a service provider, an organization chart, an organization hierarchy, a combination thereof, and the like.

At S330, the principal is matched with a compromised credential. In an embodiment, matching a principal with a compromised credential includes detecting data, metadata, and the like of a principal. In an embodiment, metadata includes, for example, a first name, a last name, a title, etc. In some embodiments, data includes an identifier of a role, a user account, a service account, and the like.

In an embodiment, a match is determined between a principal and between a compromised credential for example by providing a plurality of compromised credentials as context to a language model, and providing the language model further with a prompt including an identifier of a principal of the organization, wherein the prompt, when processed by the language model, outputs a probability that a principal of the organization is associated with a compromised credential.

In some embodiments, the match is generated based on a vector distance, a Levenshtein distance, and the like, between a compromise credential and an identifier of a principal. In an embodiment, the compromised credential, an identifier of a principal, etc., are vectorized and a cosine similarity score is generated based on the vectorizations.

In an embodiment, a generative AI is configured to generate a plurality of handles based on a detected principal. For example, in an embodiment, a credential detector is configured to detect a plurality of principals in a computing environment, and configure a generative AI to generate a plurality of handles, user identifiers, etc., based on the detected principals. In an embodiment, such generated handles for example, are used to query a database of compromised credentials.

At S340, an access instruction is generated. In an embodiment, the access instruction constitutes a penetration test. In some embodiments, a compromised credential is detected and matched to a first principal utilized by a first user who also utilizes a second principal. In an embodiment, the access instruction is generated based on the compromised credential and the second principal.

In the above example, Alice is an employee of Oceanic Airlines, having an account alice@oceanicair.com, which is detected as a compromised account. In some embodiments, the credential detector is configured to detect a second principal, alice@acme.com, which is also associated with Alice. The credential detector is then configured to generate an access instruction for an asset associated with Acme Inc., based on the compromised password of alice@oceanicair. com using the second principal of alice@acme.com. For example, in an embodiment, the access instruction includes a login attempt to a mail server associated with Acme Inc. using alice@acme. com and the password of alice@oceanicair.com.

In some embodiments, the compromised credentials include metadata of the account and an exposed password. For example, the compromised credential may be “Name: Alice C, Password: P@ssw0rd”. In an embodiment, the credential detector is configured to detect a match between “Alice C” and alice@acme.com and alice@oceanicair.com which are both associated with Acme Inc., and generate an access instruction based on each principal (e.g., alice@acme.com and alice@oceanicair.com) and the exposed password “P@ssw0rd”.

At S350, a remediation action is initiated. In an embodiment, the remediation action is initiated based on a result of executing the access instruction (i.e., performing the penetration test). For example, in an embodiment, the remediation action is initiated in response to determining that the access instruction results in successfully accessing an asset, a resource, and the like. In some embodiments, where a plurality of access instructions are generated, each for a different asset, a plurality of remediation actions are initiated.

In certain embodiment, a remediation includes revoking access to an asset, revoking access from an asset, revoking access of a principal, revoking access from a principal, resetting a credential of a principal, generating an alert, a combination thereof, and the like.

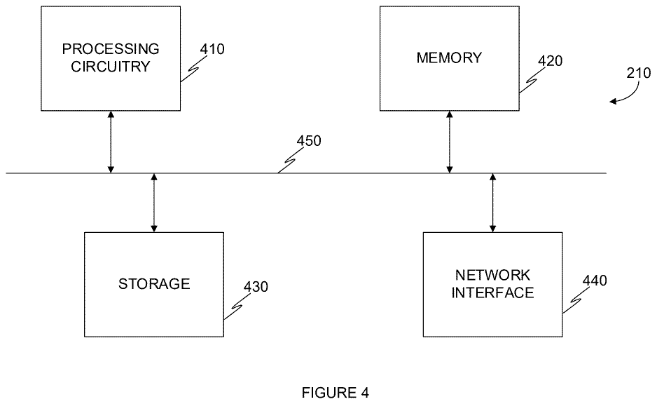

FIG. 4 is an example schematic diagram of a credential detector 210 according to an embodiment. The credential detector 210 includes, according to an embodiment, a processing circuitry 410 coupled to a memory 420, a storage 430, and a network interface 440. In an embodiment, the components of the credential detector 210 are communicatively connected via a bus 450.

In certain embodiments, the processing circuitry 410 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 420 is a volatile memory (e.g., random access memory, etc.), a non-volatile memory (e.g., read only memory, flash memory, etc.), a combination thereof, and the like. In some embodiments, the memory 420 is an on-chip memory, an off-chip memory, a combination thereof, and the like. In certain embodiments, the memory 420 is a scratch-pad memory for the processing circuitry 410.

In one configuration, software for implementing one or more embodiments disclosed herein is stored in the storage 430, in the memory 420, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 410, cause the processing circuitry 410 to perform the various processes described herein, in accordance with an embodiment.

In some embodiments, the storage 430 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 440 is configured to provide the credential detector 210 with communication with, for example, the network 250, according to an embodiment.

It should be understood that the embodiments described herein are not limited to the specific architecture illustrated in FIG. 4, and other architectures may be equally used without departing from the scope of the disclosed embodiments.

Furthermore, in certain embodiments the credential detector 210, the external attack surface detector 110, a combination thereof, and the like, may be implemented with the architecture illustrated in FIG. 4. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for validating compromised credentials of an organization, comprising:
detecting a plurality of compromised credentials, each compromised credential including a user identifier and a password;
detecting a plurality of web resources associated with an organization, each web resource including a login;
generating an instruction to access a web resource of the plurality of web resources based on a detected compromised credential; and
initiating a remediation action in response to determining that the instruction, when executed, results in access of the web resource.

2. The method of claim 1, further comprising:
initiating resource discovery to detect each of the plurality of web resources.

3. The method of claim 1, further comprising:
detecting in a user identifier of a compromised credential an identifier of the organization; and
generating the instruction only in response to detecting the identifier of the organization.

4. The method of claim 1, further comprising:
detecting a compromised credential associated with a first user identifier;
detecting a second user identifier associated with the organization, wherein the second user identifier is semantically similar to the first user identifier; and
generating the instruction to access the web resource based on the second user identifier and a password of the detected compromised credential.

5. The method of claim 1, further comprising:
detecting a digital asset associated with an external attack surface including a web resource of the plurality of web resources; and
generating an access instruction for the digital asset in response to determining that the digital asset is associated with the external attack surface of the organization.

6. The method of claim 1, further comprising:
generating a plurality of permutations based on the compromised credentials; and
generating a plurality of instructions to access the web resource, each instruction based on a permutation of the compromised credentials.

7. The method of claim 6, further comprising:
configuring a generative artificial intelligence (AI) model to generate the plurality of permutations based at least on a user identifier of a compromised credential.

8. The method of claim 6, further comprising:
configuring a generative AI model to generate the plurality of permutations based at least on a password of a compromised credential.

9. A non-transitory computer-readable medium storing a set of instructions for validating compromised credentials of an organization, the set of instructions comprising:
one or more instructions that, when executed by one or more processors of a device, cause the device to:
detect a plurality of compromised credentials, each compromised credential including a user identifier and a password;
detect a plurality of web resources associated with an organization, each web resource including a login;
generate an instruction to access a web resource of the plurality of web resources based on a detected compromised credential; and
initiate a remediation action in response to determining that the instruction, when executed, results in access of the web resource.

10. A system for validating compromised credentials of an organization comprising:
one or more processors configured to:
detect a plurality of compromised credentials, each compromised credential including a user identifier and a password;
detect a plurality of web resources associated with an organization, each web resource including a login;
generate an instruction to access a web resource of the plurality of web resources based on a detected compromised credential; and
initiate a remediation action in response to determining that the instruction, when executed, results in access of the web resource.

11. The system of claim 10, wherein the one or more processors are further configured to:
initiate resource discovery to detect each of the plurality of web resources.

12. The system of claim 10, wherein the one or more processors are further configured to:
detect in a user identifier of a compromised credential an identifier of the organization; and
generate the instruction only in response to detecting the identifier of the organization.

13. The system of claim 10, wherein the one or more processors are further configured to:
detect a compromised credential associated with a first user identifier;
detect a second user identifier associated with the organization, wherein the second user identifier is semantically similar to the first user identifier; and
generate the instruction to access the web resource based on the second user identifier and a password of the detected compromised credential.

14. The system of claim 10, wherein the one or more processors are further configured to:
detect a digital asset associated with an external attack surface including a web resource of the plurality of web resources; and
generate an access instruction for the digital asset in response to determining that the digital asset is associated with the external attack surface of the organization.

15. The system of claim 10, wherein the one or more processors are further configured to:
generate a plurality of permutations based on the compromised credentials; and
generate a plurality of instructions to access the web resource, each instruction based on a permutation of the compromised credentials.

16. The system of claim 15, wherein the one or more processors are further configured to:
configure a generative artificial intelligence (AI) model to generate the plurality of permutations based at least on a user identifier of a compromised credential.

17. The system of claim 15, wherein the one or more processors are further configured to:
configure a generative AI model to generate the plurality of permutations based at least on a password of a compromised credential.
